(19) United States
(12) Patent Application Publication
(10) Pub. No.: US 2025/0349951 A1
(43) Pub. Date: Nov. 13, 2025

(54) BATTERY AND ELECTRICAL DEVICE

(71) Applicant: Ningde Amperex Technology Limited, Ningde (CN)

(72) Inventors: Rui LI, Ningde (CN); Mingqi CHEN, Ningde (CN)

(73) Assignee: Ningde Amperex Technology Limited, Ningde (CN)

(21) Appl. No.: 19/273,576

(22) Filed: Jul. 18, 2025

Related U.S. Application Data
(63) Continuation of application No. PCT/CN2024/071772, filed on Jan. 11, 2024.

(30) Foreign Application Priority Data
Jan. 18, 2023 (CN) 202310079198.6

(51) Int. Cl. H01M 50/186; H01M 50/105; H01M 50/184

(52) U.S. Cl. CPC H01M 50/186; H01M 50/105; H01M 50/184

(57) ABSTRACT

A battery includes an electrode assembly, a packaging bag, and a tab. The electrode assembly is accommodated in the packaging bag. The packaging bag includes a first sealing edge, and the tab is connected to the electrode assembly and extends from the first sealing edge. The battery further includes a tab adhesive disposed between the first sealing edge and the tab. The tab adhesive includes a first adhesive layer, a second adhesive layer, and a third adhesive layer sequentially connected from the tab to the first sealing edge. In an stacking direction of the first adhesive layer, the second adhesive layer, and the third adhesive layer, a sum of thicknesses of the first adhesive layer, the second adhesive layer, and the third adhesive layer is 70 μm to 100 μm, and a thickness ratio of the first adhesive layer to the second adhesive layer satisfies 1:1.2-2.

### CROSS-REFERENCE

This application is a continuation application of International Application No. PCT/CN2024/071772, filed on Jan. 11, 2024, which claims the benefit of priority of Chinese patent application 202310079198.6, filed on Jan. 18, 2023, the contents of which are incorporated herein by reference in its entirety.

### TECHNICAL FIELD

The present application relates to the field of energy storage technology, and particularly to a battery and an electrical device.

### BACKGROUND

In existing battery structures, to achieve effective sealing between a tab and a packaging bag, a tab adhesive is typically required on the tab. Conventional tab adhesives do not provide pressure relief functionality, while existing tab adhesives capable of pressure relief require a lower melting point. However, tab adhesives with lower melting points lack a supporting structure during heat sealing or pressure relief, which is likely to lead to tab exposure, causing a short circuit due to contact between the tab and metal materials in the packaging bag, thus posing safety issues.

### SUMMARY

In view of the above situation, it is necessary to provide a battery capable of addressing the above issues.

An embodiment of the present application provides a battery including an electrode assembly, a packaging bag, and a tab. The electrode assembly is accommodated in the packaging bag. The packaging bag includes a first sealing edge, and the tab is connected to the electrode assembly and extends from the first sealing edge. The battery further includes a tab adhesive disposed between the first sealing edge and the tab. The tab adhesive includes a first adhesive layer, a second adhesive layer, and a third adhesive layer sequentially connected from the tab to the first sealing edge, where a melting point T1 of the first adhesive layer, a melting point T2 of the second adhesive layer, and a melting point T3 of the third adhesive layer satisfy: T1<T2, and T3<T2, where 110° C.≤T1≤130° C., 140° C.≤T2≤170° C., and 110° C.≤T3≤130° C. In an stacking direction of the first adhesive layer, the second adhesive layer, and the third adhesive layer, a sum of thicknesses of the first adhesive layer, the second adhesive layer, and the third adhesive layer is 70 μm to 100 μm, and a thickness ratio of the first adhesive layer to the second adhesive layer satisfies 1:1.2-2.

In the above battery, by specifying the melting points and thicknesses of the first adhesive layer, the second adhesive layer, and the third adhesive layer in the tab adhesive, the tab adhesive maintains a stable structure during heat sealing or pressure relief. Specifically, the melting point of the second adhesive layer is higher than the melting points of the first adhesive layer and the third adhesive layer, such that when a temperature of the tab adhesive reaches the melting points of the first adhesive layer and the third adhesive layer, the second adhesive layer remains unmelted, helping the second adhesive layer to form a supporting structure between the tab and the first sealing edge during heat sealing or pressure relief. Additionally, the thickness of the second adhesive layer is greater than the thickness of the first adhesive layer, enabling the second adhesive layer to have higher structural strength compared to the first adhesive layer, thereby enhancing stability of the support provided by the second adhesive layer between the tab and the first sealing edge. This reduces a risk of exposure of the tab due to excessive deformation of the tab adhesive causing a short circuit with metal materials in the packaging bag, thus improving safety performance of the battery.

In some embodiments of the present application, T1 and T3 are substantially equal, facilitating synchronous melting of the first adhesive layer and the third adhesive layer.

In some embodiments of the present application, the sum of the thicknesses of the first adhesive layer, the second adhesive layer, and the third adhesive layer is 72 μm to 80 μm, to further limit a packaging volume occupied by the tab adhesive, thereby increasing an energy density of the battery.

In some embodiments of the present application, a thickness ratio of the first adhesive layer, the second adhesive layer, and the third adhesive layer satisfies 1:1.2-2:1, enabling the second adhesive layer to have higher structural strength compared to the first adhesive layer and the third adhesive layer, and positioning the second adhesive layer centrally between the tab and the first sealing edge, thus further enhancing stability of the support provided by the second adhesive layer between the tab and the first sealing edge.

In some embodiments of the present application, the thickness ratio of the first adhesive layer, the second adhesive layer, and the third adhesive layer satisfies 1:1.5-1.8:1, to further limit structural strength of the first adhesive layer, the second adhesive layer, and the third adhesive layer, enhancing stability of the support provided by the second adhesive layer between the tab and the first sealing edge, thereby improving safety performance of the battery.

In some embodiments of the present application, 120° C.≤T1≤125° C., 145° C.≤T2≤165° C., and 120° C.≤T3≤125° C., to further limit the melting points of the first adhesive layer, the second adhesive layer, and the third adhesive layer, such that the melting points of the first adhesive layer and the third adhesive layer are adapted to a pressure relief temperature of the battery, and the second adhesive layer forms a supporting structure between the tab and the first sealing edge during heat sealing or pressure relief.

In some embodiments of the present application, a sealing strength of the tab adhesive at a temperature of 100° C. is 0.8 N/mm to 1.5 N/mm; the sealing strength of the tab adhesive at a temperature of 120° C. is 0.6 N/mm to 1.2 N/mm; and the sealing strength of the tab adhesive at a temperature of 130° C. is 0.2 N/mm to 0.5 N/mm. When the temperature of the tab adhesive reaches the melting points of the first adhesive layer and the third adhesive layer, the sealing strength of the tab adhesive decreases, facilitating separation of at least one of the first adhesive layer or the third adhesive layer from the second adhesive layer to form a pressure relief channel in the tab adhesive.

In some embodiments of the present application, the sealing strength of the tab adhesive at room temperature is 2.3 N/mm to 4.25 N/mm. When the tab adhesive is at room temperature, the tab adhesive maintains a high sealing strength, improving stability of sealing between the tab and the first sealing edge.

In some embodiments of the present application, viewed along a thickness direction of the tab, the tab adhesive includes a top portion, a bottom portion, a first side portion, and a second side portion. The top portion and the bottom portion are oppositely disposed in an extension direction of the tab, the top portion is located outside the first sealing edge, and the bottom portion is located inside the packaging bag. The first side portion and the second side portion are connected between the top portion and the bottom portion and are disposed on two sides of the tab along a width direction of the tab.

In some embodiments of the present application, along the extension direction of the tab, a width of the first sealing edge is 1.2 mm to 2.0 mm, and along the width direction of the tab, a spacing between the first side portion and the second side portion is 8 mm to 9 mm. A wider first sealing edge results in a longer path for pressure relief, making pressure relief more difficult, while a narrower first sealing edge facilitates pressure relief. A larger spacing between the first side portion and the second side portion increases a connection length of the tab adhesive with an external environment, enhancing provision of low-melting-point positions. Thus, the first side portion and the second side portion being longer facilitate pressure relief. By balancing the spacing between the first side portion and the second side portion and the width of the first sealing edge, formation of the pressure relief channel is neither too early nor too late.

In some embodiments of the present application, a length by which the top portion protrudes beyond the first sealing edge is 0.2 mm to 2 mm, and a length by which the bottom portion protrudes beyond the first sealing edge is greater than 1.2 mm, to reduce a risk of exposure of the tab causing a short circuit with metal materials in the packaging bag, thereby improving safety performance of the battery.

In some embodiments of the present application, along the extension direction of the tab, a spacing between the top portion and the bottom portion is 2.5 mm to 5 mm, helping the tab adhesive to extend from the inside of the packaging bag through the first sealing edge to the outside of the packaging bag, thus enhancing a sealing effect of the tab adhesive.

In some embodiments of the present application, along the width direction of the tab, a spacing between a side edge of the tab facing the first side portion and the first side portion is 0.5 mm to 2.5 mm, and a spacing between a side edge of the tab facing the second side portion and the second side portion is 0.5 mm to 2.5 mm, helping the tab adhesive to protrude beyond two sides of the tab in the width direction of the tab, thus enhancing the sealing effect of the tab adhesive.

In some embodiments of the present application, the tab includes a first surface and a second surface oppositely disposed in the thickness direction, and the tab adhesive includes a first portion and a second portion. The first portion is connected between the first surface and the first sealing edge, and the second portion is connected between the second surface and the first sealing edge. Along the width direction of the tab, two ends of the first portion protruding beyond the first surface are connected to two ends of the second portion protruding beyond the second surface, such that the tab adhesive envelops a peripheral side of the tab.

An embodiment of the present application further provides an electrical device, including the battery according to any one of the foregoing embodiments.

In the battery and the electrical device of the present application, by specifying the melting points and thicknesses of the first adhesive layer, the second adhesive layer, and the third adhesive layer in the tab adhesive, the tab adhesive maintains a stable structure during heat sealing or pressure relief. Specifically, the melting point of the second adhesive layer is higher than the melting points of the first adhesive layer and the third adhesive layer, such that when the temperature of the tab adhesive reaches the melting points of the first adhesive layer and the third adhesive layer, the second adhesive layer remains unmelted, helping the second adhesive layer to form a supporting structure between the tab and the first sealing edge during heat sealing or pressure relief. Additionally, the thickness of the second adhesive layer is greater than the thickness of the first adhesive layer, enabling the second adhesive layer to have higher structural strength compared to the first adhesive layer, thereby enhancing stability of the support provided by the second adhesive layer between the tab and the first sealing edge. This reduces the risk of exposure of the tab due to excessive deformation of the tab adhesive causing a short circuit with metal materials in the packaging bag, thus improving safety performance of the battery.

### BRIEF DESCRIPTION OF DRAWINGS

FIG. 1 is a schematic structural diagram of a battery according to an embodiment of the present application.

FIG. 2 is a schematic structural diagram of a tab adhesive of a battery from a first perspective according to an embodiment of the present application.

FIG. 3 is a schematic structural diagram of a tab adhesive of a battery from a second perspective according to an embodiment of the present application.

FIG. 4 is a schematic structural diagram of a tab adhesive of a battery in a pressure relief state according to an embodiment of the present application.

FIG. 5 is a schematic structural diagram of a cut portion in a sealing strength test of the present application.

FIG. 6 is a schematic structural diagram of a sample in a sealing strength test of the present application.

FIG. 7 is a schematic structural diagram of an electrical device according to an embodiment of the present application.

### DESCRIPTION OF MAIN COMPONENT SYMBOLS

battery 100
electrical device 200
electrode assembly 10
packaging bag 20
first sealing edge 21
first melting layer 211
second melting layer 212
tab 30
first surface 31
second surface 32
first segment 33
second segment 34
tab adhesive 40
first adhesive layer 41
second adhesive layer 42
third adhesive layer 43
first portion 40a
second portion 40b
top portion 44
bottom portion 45
first side portion 46
second side portion 47
pressure relief channel 50
cutting start point 61
cutting end point 62
cut portion 63
packaging portion 631
extension portion 632
first clamping end 64
second clamping end 65
thickness direction Z
extension direction X
width direction Y

The following specific embodiments will further illustrate the present application with reference to the above drawings.

### DETAILED DESCRIPTION

The technical solutions in some embodiments of the present application will be described below with reference to the drawings in these embodiments of the present application. Apparently, the described embodiments are only some of embodiments of the present application, not all embodiments.

It should be noted that when a component is assumed to be “connected” to another component, the component may be connected to the another component directly or with a component possibly present therebetween. When a component is assumed to be “disposed on or in” another component, the component may be provided directly on or in the another component or with a component possibly present therebetween. When a value is considered “substantially equal to” another value, the two values are equal within a set deviation, with the set deviation range being within 5%. That is, when at least one of the two values fluctuates within the set deviation range, even if the values are not equal, the values are still deemed substantially equal. When a value is considered to have a ratio of “1:1” with another value, the two values are equal within a set deviation, with the set deviation range being within 5%. That is, when at least one of the two values fluctuates within the set deviation range, even if the values are not equal, the ratio is still deemed equal.

Unless otherwise defined, all technical and scientific terms used herein have the same meaning as commonly understood by those skilled in the technical field of the present application. The terms used in the specification of the present application herein are for the purpose of describing specific embodiments only and are not intended to limit the present application. The term “and/or” used herein includes any and all combinations of one or more associated items listed.

An embodiment of the present application provides a battery including an electrode assembly, a packaging bag, and a tab. The electrode assembly is accommodated in the packaging bag. The packaging bag includes a first sealing edge, and the tab is connected to the electrode assembly and extends from the first sealing edge. The battery further includes a tab adhesive disposed between the first sealing edge and the tab. The tab adhesive includes a first adhesive layer, a second adhesive layer, and a third adhesive layer sequentially connected from the tab to the first sealing edge, where a melting point T1 of the first adhesive layer, a melting point T2 of the second adhesive layer, and a melting point T3 of the third adhesive layer satisfy: T1<T2, and T3<T2, where 110° C.≤T1≤130° C., 140° C.≤T2≤170° C., and 110° C.≤T3≤130° C. In an stacking direction of the first adhesive layer, the second adhesive layer, and the third adhesive layer, a sum of thicknesses of the first adhesive layer, the second adhesive layer, and the third adhesive layer is 70 μm to 100 μm, and a thickness ratio of the first adhesive layer to the second adhesive layer satisfies 1:1.2-2.

In the above battery, by specifying the melting points and thicknesses of the first adhesive layer, the second adhesive layer, and the third adhesive layer in the tab adhesive, the tab adhesive maintains a stable structure during heat sealing or pressure relief. Specifically, the melting point of the second adhesive layer is higher than the melting points of the first adhesive layer and the third adhesive layer, such that when a temperature of the tab adhesive reaches the melting points of the first adhesive layer and the third adhesive layer, the second adhesive layer remains unmelted, helping the second adhesive layer to form a supporting structure between the tab and the first sealing edge during heat sealing or pressure relief. Additionally, the thickness of the second adhesive layer is greater than the thickness of the first adhesive layer, enabling the second adhesive layer to have higher structural strength compared to the first adhesive layer, thereby enhancing stability of the support provided by the second adhesive layer between the tab and the first sealing edge. This reduces a risk of exposure of the tab due to excessive deformation of the tab adhesive causing a short circuit with metal materials in the packaging bag, thus improving safety performance of the battery.

The following further describes some embodiments of the present application with reference to the accompanying drawings.

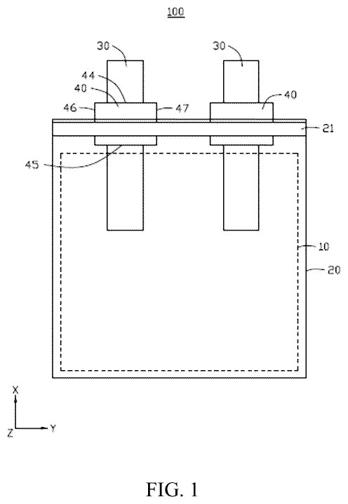

Referring to FIG. 1, an embodiment of the present application provides a battery 100, where the battery 100 includes an electrode assembly 10, a packaging bag 20, a tab 30, and a tab adhesive 40. The electrode assembly 10 is formed by stacking or winding a positive electrode plate, a separator, and a negative electrode plate. The electrode assembly 10 is accommodated in the packaging bag 20 for storing or releasing electrical energy. The packaging bag 20 includes a first sealing edge 21, and the tab 30 is connected to the electrode assembly 10 and extends from the first sealing edge 21, with a portion of the tab 30 extending from the first sealing edge 21 used to connect to a circuit board assembly or an external electrical device.

Optionally, the battery 100 includes two tabs 30, where the two tabs 30 are spaced apart and respectively connected to the positive electrode plate and the negative electrode plate in the electrode assembly 10, such that the two tabs 30 have opposite polarities.

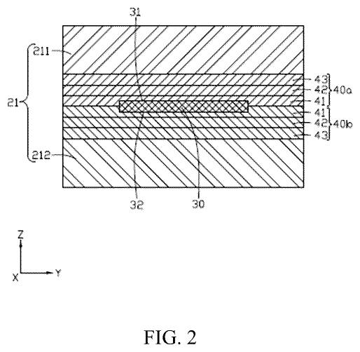

Referring to FIG. 2, the tab adhesive 40 is disposed between the tab 30 and the first sealing edge 21. Specifically, the first sealing edge 21 includes a first melting layer 211 and a second melting layer 212 sealed together in a thickness direction Z of the tab 30, forming an opening 213 between the first melting layer 211 and the second melting layer 212 for the tab 30 to extend through. The tab adhesive 40 envelops a peripheral side of the tab 30, with at least a portion of the tab adhesive 40 located in the opening 213 and sealed with the first melting layer 211 and the second melting layer 212.

In some embodiments, the tab 30 includes a first surface 31 and a second surface 32 oppositely disposed in the thickness direction Z of the tab 30. The tab adhesive 40 includes a first portion 40a and a second portion 40b, where the first portion 40a is connected between the first surface 31 and the first melting layer 211, and the second portion 40b is connected between the second surface 32 and the second melting layer 212. In a width direction Y of the tab 30, two ends of the first portion 40a protruding beyond the first surface 31 are connected to two ends of the second portion 40b protruding beyond the second surface 32, such that the tab adhesive 40 envelops the peripheral side of the tab 30.

It can be understood that, in some embodiments, the tab adhesive 40 may surround the tab 30, such that the tab adhesive 40 envelops the peripheral side of the tab 30.

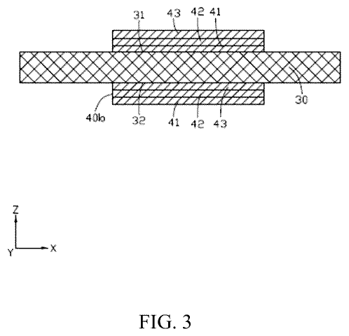

Referring to FIG. 3, the tab adhesive 40 includes a first adhesive layer 41, a second adhesive layer 42, and a third adhesive layer 43 sequentially connected from the tab 30 to the first sealing edge 21. Specifically, in the first portion 40a, the first adhesive layer 41, the second adhesive layer 42, and the third adhesive layer 43 are sequentially disposed from the first surface 31 to the first melting layer 211. In the second portion 40b, the first adhesive layer 41, the second adhesive layer 42, and the third adhesive layer 43 are sequentially disposed from the second surface 32 to the second melting layer 212.

Optionally, the first adhesive layer 41 and the third adhesive layer 43 are formed on two sides of the second adhesive layer 42 by copolymerization of propylene, ethylene, or butene; or the first adhesive layer 41 and the third adhesive layer 43 are formed on two sides of the second adhesive layer 42 by blending polypropylene with a polyethylene octene co-elastomer having a different melting point; or the first adhesive layer 41 and the third adhesive layer 43 are formed on two sides of the second adhesive layer 42 by blending polypropylene and polyethylene.

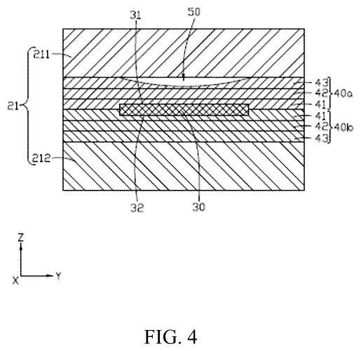

Referring to FIG. 4, a melting point T1 of the first adhesive layer 41, a melting point T2 of the second adhesive layer 42, and a melting point T3 of the third adhesive layer 43 satisfy: T1<T2, and T3<T2, where 110° C.≤T1≤130° C., 140° C.≤T2≤170° C., and 110° C.≤T3≤130° C. It can be understood that the melting points of the first adhesive layer 41 and the third adhesive layer 43 are adapted to a pressure relief temperature of the battery 100. When a temperature of the tab adhesive 40 reaches the melting points of the first adhesive layer 41 and the third adhesive layer 43, the second adhesive layer 42 remains unmelted, helping the second adhesive layer 42 to form a supporting structure between the tab 30 and the first sealing edge 21 during heat sealing or pressure relief, and reducing a risk of exposure of the tab 30 causing a short circuit with metal materials in the packaging bag 20, thereby improving safety performance of the battery 100. Specifically, during pressure relief, the first adhesive layer 41 and the third adhesive layer 43 separately melt, and at least one of the first adhesive layer 41 or the third adhesive layer 43 separates from the second adhesive layer 42, causing the tab adhesive 40 to form a pressure relief channel 50. Additionally, the second adhesive layer 42 can limit an amount of adhesive overflow during pressure relief.

Optionally, during pressure relief, the first adhesive layer 41 separates from the second adhesive layer 42, causing the tab adhesive 40 to form a pressure relief channel 50 on a side facing the tab 30; or the third adhesive layer 43 separates from the second adhesive layer 42, causing the tab adhesive 40 to form a pressure relief channel 50 on a side facing the first sealing edge 21; or the first adhesive layer 41 separates from the third adhesive layer 43, causing the tab adhesive 40 to form pressure relief channels 50 on two sides. The first adhesive layer 41 and the second adhesive layer 42 can increase a probability of the tab adhesive 40 forming a pressure relief channel 50, improving safety performance of the battery.

Optionally, T1 and T3 may be 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., or any other value within the range of 110° C.≤T1≤130° C.

Optionally, T2 may be 140° C., 141° C., 142° C., 143° C., 144° C., 145° C., 148° C., 150° C., 153° C., 155° C., 158° C., 160° C., 161° C., 162° C., 163° C., 164° C., 165° C., 166° C., 167° C., 168° C., 169° C., 170° C., or any other value within the range of 140° C.≤T2≤170° C.

In some embodiments, T1=T3, facilitating synchronous melting of the first adhesive layer 41 and the third adhesive layer 43.

It can be understood that, in some embodiments, T1>T3 or T1<T3, and synchronous melting may occur when the temperature of the tab adhesive 40 reaches a higher melting point of the first adhesive layer 41 and the third adhesive layer 43.

Further, the melting point T1 of the first adhesive layer 41, the melting point T2 of the second adhesive layer 42, and the melting point T3 of the third adhesive layer 43 satisfy: 120° C.≤T1≤125° C., 145° C.≤T2≤165° C., and 120° C.≤T3≤125° C., to further limit the melting points of the first adhesive layer 41, the second adhesive layer 42, and the third adhesive layer 43, such that the melting points of the first adhesive layer 41 and the third adhesive layer 43 are adapted to the pressure relief temperature of the battery 100, and the second adhesive layer 42 forms a supporting structure between the tab 30 and the first sealing edge 21 during heat sealing or pressure relief.

Further, the melting point T1 of the first adhesive layer 41, the melting point T2 of the second adhesive layer 42, and the melting point T3 of the third adhesive layer 43 satisfy: T1=T3=123° C.; and T2=165° C., to further limit the melting points of the first adhesive layer 41, the second adhesive layer 42, and the third adhesive layer 43, such that the melting points of the first adhesive layer 41 and the third adhesive layer 43 are adapted to the pressure relief temperature of the battery 100, and the second adhesive layer 42 forms a supporting structure between the tab 30 and the first sealing edge 21 during heat sealing or pressure relief.

Referring again to FIG. 2 and FIG. 3, in some embodiments, in the stacking direction of the first adhesive layer 41, the second adhesive layer 42, and the third adhesive layer 43, the sum of the thicknesses of the first adhesive layer 41, the second adhesive layer 42, and the third adhesive layer 43 is 70 μm to 100 μm, to limit a packaging volume occupied by the tab adhesive 40, thereby increasing an energy density of the battery 100.

Further, the sum of the thicknesses of the first adhesive layer 41, the second adhesive layer 42, and the third adhesive layer 43 is 72 μm to 80 μm, to further limit the packaging volume occupied by the tab adhesive 40, thereby increasing the energy density of the battery 100.

Optionally, the sum of the thicknesses of the first adhesive layer 41, the second adhesive layer 42, and the third adhesive layer 43 may be 72 μm, 73 μm, 74 μm, 75 μm, 76 μm, 77 μm, 78 μm, 79 μm, 80 μm, or any other value within the range of 72 μm to 80 μm.

Referring again to FIG. 4, in some embodiments, a thickness ratio of the first adhesive layer 41 to the second adhesive layer 42 satisfies 1:1.2-2, enabling the second adhesive layer 42 to have higher structural strength compared to the first adhesive layer 41, enhancing stability of the support provided by the second adhesive layer 42 between the tab 30 and the first sealing edge 21, and reducing a risk of exposure of the tab 30 due to excessive deformation of the tab adhesive 40 causing a short circuit with metal materials in the packaging bag 20, thereby improving safety performance of the battery.

It should be noted that, during packaging, the first adhesive layer 41 contacts the tab 30, and under compression by the tab 30, a thickness of the first adhesive layer 41 at a position corresponding to the tab 30 decreases. In the present application, the thickness of the first adhesive layer 41 refers to an initial thickness of the first adhesive layer 41 before compression by the tab 30, that is, the thickness of a portion of the first adhesive layer 41 extending beyond the tab 30 in the width direction Y of the tab 30 as shown in FIG. 2.

It can be understood that, in some embodiments, a surface of the first adhesive layer 41 contacting the tab 30 under compression by the tab 30 forms a rough surface, where the rough surface includes a plurality of first concave surfaces and first convex surfaces continuously arranged in the width direction Y of the tab 30, and the rough surface abuts the first surface 31 or the second surface 32 of the tab 30, to enhance a connection strength between the first adhesive layer 41 and the tab 30.

Further, a thickness of the first adhesive layer 41 is substantially equal to a thickness of the third adhesive layer 43, and a thickness ratio of the first adhesive layer 41, the second adhesive layer 42, and the third adhesive layer 43 satisfies 1:1.2-2:1, enabling the second adhesive layer 42 to have higher structural strength compared to the first adhesive layer 41 and the third adhesive layer 43, and positioning the second adhesive layer 42 centrally between the tab 30 and the first sealing edge 21, thus further enhancing stability of the support provided by the second adhesive layer 42 between the tab 30 and the first sealing edge 21.

Optionally, the thickness ratio of the first adhesive layer 41, the second adhesive layer 42, and the third adhesive layer 43 may be 1:1.2-2:1, 1:1.3:1, 1:1.4:1, 1:1.5:1, 1:1.6:1, 1:1.7:1, 1:1.8:1, 1:1.9:1, 1:2:1, or any other value within the range of 1:1.2-2:1.

In some embodiments, the sum of the thicknesses of the first adhesive layer 41, the second adhesive layer 42, and the third adhesive layer 43 is 75.5 μm, the thickness of the first adhesive layer 41 is 20 μm, the thickness of the second adhesive layer 42 is 35.5 μm, and the thickness of the third adhesive layer 43 is 20 μm.

Further, the thickness ratio of the first adhesive layer 41, the second adhesive layer 42, and the third adhesive layer 43 satisfies 1:1.5-1.8:1, to further limit structural strength of the first adhesive layer 41, the second adhesive layer 42, and the third adhesive layer 43, enhancing stability of the support provided by the second adhesive layer 42 between the tab 30 and the first sealing edge 21, thereby improving safety performance of the battery 100.

In some embodiments, the sum of the thicknesses of the first adhesive layer 41, the second adhesive layer 42, and the third adhesive layer 43 is 77 μm, the thickness of the first adhesive layer 41 is 22 μm, the thickness of the second adhesive layer 42 is 33 μm, and the thickness of the third adhesive layer 43 is 22 μm.

Further, the thickness ratio of the first adhesive layer 41, the second adhesive layer 42, and the third adhesive layer 43 satisfies 1:1.6:1, to further limit structural strength of the first adhesive layer 41, the second adhesive layer 42, and the third adhesive layer 43, enhancing stability of the support provided by the second adhesive layer 42 between the tab 30 and the first sealing edge 21, thereby improving safety performance of the battery 100.

In some embodiments, the sum of the thicknesses of the first adhesive layer 41, the second adhesive layer 42, and the third adhesive layer 43 is 72 μm, the thickness of the first adhesive layer 41 is 20 μm, the thickness of the second adhesive layer 42 is 32 μm, and the thickness of the third adhesive layer 43 is 20 μm.

It can be understood that, in some embodiments, provided that the thickness of the second adhesive layer 42 is greater than the thickness of the third adhesive layer 43, the thickness of the first adhesive layer 41 being greater than the thickness of the third adhesive layer 43, or the thickness of the first adhesive layer 41 being less than the thickness of the third adhesive layer 43, enables the second adhesive layer 42 to have higher structural strength compared to the first adhesive layer 41 and the third adhesive layer 43, helping the second adhesive layer 42 to have sufficient structural strength to provide support between the tab 30 and the first sealing edge 21.

In the above battery 100, by specifying the melting points and thicknesses of the first adhesive layer 41, the second adhesive layer 42, and the third adhesive layer 43 in the tab adhesive 40, the tab adhesive 40 maintains a stable structure during pressure relief. Specifically, the melting point of the second adhesive layer 42 is higher than the melting points of the first adhesive layer 41 and the third adhesive layer 43, such that when the temperature of the tab adhesive 40 reaches the melting points of the first adhesive layer 41 and the third adhesive layer 43, the second adhesive layer 42 remains unmelted, helping the second adhesive layer 42 to form a supporting structure between the tab 30 and the first sealing edge 21 during heat sealing or pressure relief. Additionally, the thickness of the second adhesive layer 42 is greater than the thickness of the first adhesive layer 41, enabling the second adhesive layer 42 to have higher structural strength compared to the first adhesive layer 41, thereby enhancing stability of the support provided by the second adhesive layer 42 between the tab 30 and the first sealing edge 21. This reduces a risk of exposure of the tab 30 due to excessive deformation of the tab adhesive 40 causing a short circuit with metal materials in the packaging bag 20, thus improving safety performance of the battery 100.

In some embodiments, a sealing strength of the tab adhesive 40 at room temperature is 2.3 N/mm to 4.2 N/mm; the sealing strength of the tab adhesive 40 at a temperature of 100° C. is 0.8 N/mm to 1.5 N/mm; the sealing strength of the tab adhesive 40 at a temperature of 120° C. is 0.6 N/mm to 1.2 N/mm; and the sealing strength of the tab adhesive 40 at a temperature of 130° C. is 0.2 N/mm to 0.5 N/mm. A portion of the tab adhesive 40 is located inside the packaging bag 20, and a temperature inside the packaging bag 20 is the temperature of the tab adhesive 40. As compared with the sealing strength of conventional tab adhesives, the above settings result in a greater variation in the sealing strength of the tab adhesive 40 with temperature changes. When the tab adhesive 40 is at room temperature of 25° C., the tab adhesive 40 maintains a high sealing strength, improving stability of sealing between the tab 30 and the first sealing edge 21. When the temperature of the tab adhesive 40 reaches the melting points of the first adhesive layer 41 and the third adhesive layer 43, the sealing strength of the tab adhesive 40 decreases, facilitating separation of at least one of the first adhesive layer 41 or the third adhesive layer 43 from the second adhesive layer 42 to form a pressure relief channel in the tab adhesive 40.

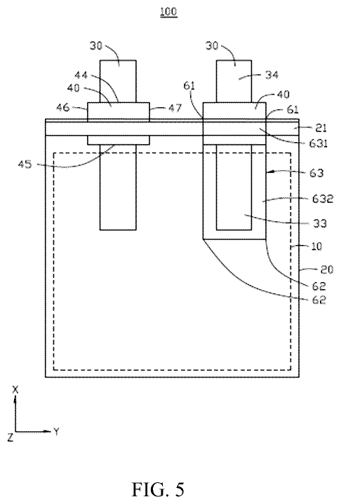

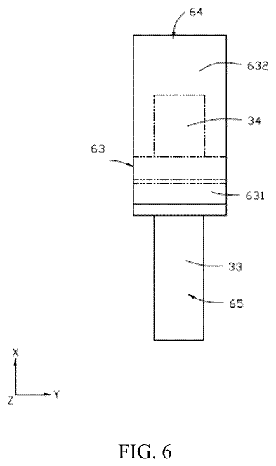

Referring to FIG. 5 and FIG. 6, it should be noted that the sealing strength in the present application is obtained through the following test method:

### Step 1: Prepare a Sample.

Specifically, in the width direction Y of the tab 30, two cutting start points 61 are defined at portions of the first sealing edge 21 located on two sides of the tab adhesive 40. The tab 30 includes a first segment 33 extending from the tab adhesive 40 into the packaging bag 20 and a second segment 34 extending from the tab adhesive 40 to the outside of the packaging bag 20. From each cutting start point 61, the packaging bag 20 is cut along the extension direction X of the tab 30 until a cutting end point 62 extends beyond an end of the first segment 33 away from the first segment 33, forming a cut portion 63 by cutting to the two cutting end points 62. The cut portion 63 includes the tab 30, the tab adhesive 40 enveloping the tab 30, and a portion of the packaging bag 20 connected to two sides of the tab adhesive 40 in the thickness direction Z of the tab 30.

The packaging bag 20 in the cut portion 63 includes a packaging portion 631 connected to the tab adhesive 40 and an extension portion 632 extending from the packaging portion 631 to the first segment 33. The extension portion 632 is folded to cover the packaging portion 631 and the second segment 34 to form a sample. The sample includes a first clamping end 64 and a second clamping end 65, where the first clamping end 64 is a portion of the two extension portions 632 extending beyond the second segment 34 after folding, and the second clamping end 65 is the first segment 33 exposed after the two extension portions 632 are folded.

### Step 2: Perform a Tensile Test.

Specifically, a tensile testing machine with a temperature box is used, where the tensile testing machine has two opposing clamps in the temperature box. The sample is placed in the temperature box, with one clamp holding the first clamping end 64 and the other clamp holding the second clamping end 65. After the temperature box reaches a specified temperature and is maintained for 5 minutes, the two clamps are moved relative to each other at a speed of 175±5 mm/min to perform the tensile test, and a maximum value is recorded when the tab adhesive 40 detaches from the tab 30 or the packaging bag 20.

Optionally, the sealing strength of the tab adhesive 40 at room temperature may be 2.3 N/mm, 2.5 N/mm, 2.6 N/mm, 2.9 N/mm, 3.0 N/mm, 3.3 N/mm, 3.6 N/mm, 3.8 N/mm, 4.0 N/mm, 4.2 N/mm, or any other value within the range of 2.3 N/mm to 4.2 N/mm.

Optionally, the sealing strength of the tab adhesive 40 at 100° C. may be 0.8 N/mm, 0.9 N/mm, 1.0 N/mm, 1.1 N/mm, 1.2 N/mm, 1.3 N/mm, 1.4 N/mm, 1.5 N/mm, or any other value within the range of 0.8 N/mm to 1.5 N/mm.

Optionally, the sealing strength of the tab adhesive 40 at 120° C. may be 0.6 N/mm, 0.7 N/mm, 0.8 N/mm, 0.9 N/mm, 1.0 N/mm, 1.1 N/mm, 1.2 N/mm, or any other value within the range of 0.6 N/mm to 1.2 N/mm.

Optionally, the sealing strength of the tab adhesive 40 at 130° C. may be 0.2 N/mm, 0.3 N/mm, 0.4 N/mm, 0.5 N/mm, or any other value within the range of 0.2 N/mm to 0.5 N/mm.

In the above battery 100, by specifying the melting point of the first adhesive layer 41, the melting point of the second adhesive layer 42, the melting point of the third adhesive layer 43 in the tab adhesive 40, and the sealing strength of the tab adhesive 40 at various temperatures, a balance is achieved between the melting points and the sealing strength of the tab adhesive 40. When the temperature of the tab adhesive 40 reaches the melting points of the first adhesive layer 41 and the third adhesive layer 43, the second adhesive layer 42 remains unmelted, helping the second adhesive layer 42 to form a supporting structure between the tab 30 and the first sealing edge 21 during heat sealing or pressure relief, and the sealing strength of the tab adhesive 40 decreases, facilitating separation of at least one of the first adhesive layer 41 or the third adhesive layer 43 from the second adhesive layer 42 to form a pressure relief channel 50 in the tab adhesive 40.

Referring again to FIG. 1, viewed along the thickness direction Z of the tab 30, the tab adhesive 40 includes a top portion 44, a bottom portion 45, a first side portion 46, and a second side portion 47. The top portion 44 and the bottom portion 45 are oppositely disposed in an extension direction X of the tab 30, the top portion 44 is located outside the packaging bag 20, and the bottom portion 45 is located inside the packaging bag 20. The first side portion 46 and the second side portion 47 are connected between the top portion 44 and the bottom portion 45 and are oppositely disposed on two sides of the tab 30 along a width direction Y of the tab 30.

Along the extension direction X of the tab 30, a width of the first sealing edge 21 is 1.2 mm to 2.0 mm, a length by which the top portion 44 protrudes beyond the first sealing edge 21 is 0.2 mm to 2 mm, and a length by which the bottom portion 45 protrudes beyond the first sealing edge is greater than 1.2 mm, to reduce a risk of exposure of the tab 30 causing a short circuit with metal materials in the packaging bag 20, thereby improving safety performance of the battery 100.

Optionally, the width of the first sealing edge 21 may be 1.2 mm, 1.3 mm, 1.4 mm, 1.5 mm, 1.6 mm, 1.7 mm, 1.8 mm, 1.9 mm, 2.0 mm, or any other value within the range of 1.2 mm to 2.0 mm.

Optionally, the length by which the top portion 44 protrudes beyond the first sealing edge 21 may be 0.2 mm, 0.3 mm, 0.4 mm, 0.5 mm, 0.6 mm, 0.8 mm, 1 mm, 1.2 mm, 1.4 mm, 1.6 mm, 1.8 mm, 2 mm, or any other value within the range of 0.2 mm to 2 mm.

Optionally, the length by which the bottom portion 45 protrudes beyond the first sealing edge may be 1.3 mm, 1.4 mm, 1.6 mm, 1.8 mm, 2 mm, or any other value greater than 1.2 mm.

Along the width direction Y of the tab 30, a spacing between the first side portion 46 and the second side portion 47 is 8 mm to 9 mm, to increase an extension length of the bottom portion 45 inside the packaging bag 20, thereby increasing low-melting-point positions of the tab 30, helping the tab adhesive 40 to form a pressure relief channel 50 when a temperature inside the packaging bag 20 reaches the melting points of the first adhesive layer 41 and the third adhesive layer 43.

Optionally, the spacing between the first side portion 46 and the second side portion 47 may be 8 mm, 8.1 mm, 8.2 mm, 8.3 mm, 8.4 mm, 8.5 mm, 8.6 mm, 8.7 mm, 8.8 mm, 8.9 mm, 9 mm, or any other value within the range of 8 mm to 9 mm.

Along the extension direction X of the tab 30, a spacing between the top portion 44 and the bottom portion 45 is 2.5 mm to 5 mm, helping the tab adhesive 40 to extend from the inside of the packaging bag 20 through the first sealing edge 21 to the outside of the packaging bag 20, thus enhancing a sealing effect of the tab adhesive 40.

Optionally, the spacing between the top portion 44 and the bottom portion 45 may be 2.5 mm, 3 mm, 3.5 mm, 4 mm, 4.5 mm, 5 mm, or any other value within the range of 2.5 mm to 5 mm.

Along the width direction Y of the tab 30, a spacing between a side edge of the tab 30 facing the first side portion 46 and the first side portion 46 is 0.5 mm to 2.5 mm, and a spacing between a side edge of the tab 30 facing the second side portion 47 and the second side portion 47 is 0.5 mm to 2.5 mm, helping the tab adhesive 40 to protrude beyond two sides of the tab 30 in the width direction Y of the tab 30, thus enhancing the sealing effect of the tab adhesive 40.

Optionally, the spacing between the side edge of the tab 30 facing the first side portion 46 and the first side portion 46 may be 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, or any other value within the range of 0.5 mm to 2.5 mm.

Optionally, the spacing between the side edge of the tab 30 facing the second side portion 47 and the second side portion 47 may be 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, or any other value within the range of 0.5 mm to 2.5 mm.

In some embodiments, along the width direction Y of the tab 30, the tab 30 is centrally disposed between the first side portion 46 and the second side portion 47, such that the spacing between the side edge of the tab 30 facing the first side portion 46 and the first side portion 46 is equal to the spacing between the side edge of the tab 30 facing the second side portion 47 and the second side portion 47, ensuring uniform stress on two sides of the tab 30.

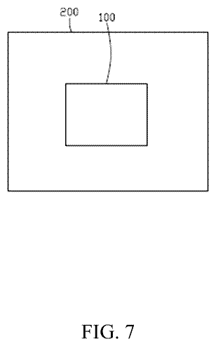

Referring to FIG. 7, an embodiment of the present application further provides an electrical device 200, including the battery 100 according to any one of the above embodiments. The electrical device 200 further includes a device body, where the battery 100 is electrically connected to the device body and supplies power to the device body. In some embodiments, the device body may be an electronic device such as a mobile phone or tablet computer, or a transportation device such as an electric vehicle.

The following illustrates the present application through specific embodiments:

Pressure relief tests include a hot box test and a 100° C. storage test.

The hot box test includes the following four steps:

Charge a battery until a remaining capacity of the battery reaches 100%.

Attach a temperature sensor to a center of a surface of the battery.

Place the battery flat in a box and heat it at a rate of 5±2° C. to 130±2° C., and maintain the temperature for 60 minutes.

Turn off box heating, remove the battery after the battery cools to room temperature, and determine that the battery meets safety standards if the battery does not catch fire or explode.

The hot box storage test includes the following three steps:

Charge a battery until a remaining capacity of the battery reaches 100%.

Store the battery in a box at 100±2° C. for 5 h.

Open the box, remove the battery, and determine that the battery meets safety standards if no sealing edge of the battery is breached and the battery does not catch fire or explode.

Batteries of comparative examples and examples are placed in a temperature box, and pressure relief conditions of the batteries are observed after the temperature box reaches a specified temperature.

The batteries in the comparative examples and examples have mostly identical parameters and may adopt commonly used chemical systems and cell structures in the field. Parameters other than those specified in the following tables are identical across the examples and comparative examples.

TABLE 1
Remaining parameters and test results of batteries
in Comparative Examples 1 and 2 and Examples 1-4

| | Comparative | Comparative | Example | Example | Example | Example | Example |
|---|---|---|---|---|---|---|---|
| Group | Example 1 | Example 2 | 1 | 2 | 3 | 4 | 5 |
| T1 (° C.) | 105 | 145 | 110 | 120 | 123 | 125 | 130 |
| T2 (° C.) | 165 | 165 | 165 | 165 | 165 | 165 | 165 |
| T3 (° C.) | 105 | 145 | 110 | 120 | 123 | 125 | 130 |
| Sealing | 3.2 | 3.2 | 3.2 | 3.2 | 3.2 | 3.2 | 3.2 |
| strength at | | | | | | | |
| room | | | | | | | |
| temperature | | | | | | | |
| (N/mm) | | | | | | | |
| Sealing | 0.5 | 1.6 | 0.6 | 1.1 | 1.2 | 1.3 | 1.4 |
| strength at | | | | | | | |
| 100° C. | | | | | | | |
| (N/mm) | | | | | | | |
| Sealing | 0.3 | 1.2 | 0.3 | 0.8 | 0.9 | 0.9 | 1 |
| strength at | | | | | | | |
| 120° C. | | | | | | | |
| (N/mm) | | | | | | | |
| Sealing | 0.3 | 1 | 0.3 | 0.3 | 0.3 | 0.3 | 0.8 |
| strength at | | | | | | | |
| 130° C. | | | | | | | |
| (N/mm) | | | | | | | |
| Sum of | 75 | 75 | 75 | 75 | 75 | 75 | 75 |
| thicknesses | | | | | | | |
| (μm) | | | | | | | |
| Thickness | 1:1.6:1 | 1:1.6:1 | 1:1.6:1 | 1:1.6:1 | 1:1.6:1 | 1:1.6:1 | 1:1.6:1 |
| ratio | | | | | | | |
| Pass rate of | 100% | 30% | 100% | 100% | 100% | 100% | 80% |
| hot box test | | | | | | | |
| Pass rate of | 0% | 100% | 80% | 100% | 100% | 100% | 100% |
| 100° C. storage | | | | | | | |
| test | | | | | | | |

From Table 1, it can be seen that in Comparative Example 1, the melting points of the first adhesive layer 41 and the third adhesive layer 43 are less than 110° C., which is unfavorable for high-temperature storage of the battery 100. In Comparative Example 2, the melting points of the first adhesive layer 41 and the third adhesive layer 43 are greater than 130° C., which is unfavorable for timely pressure relief of the battery 100. In Examples 1-5, the melting points of the first adhesive layer 41 and the third adhesive layer 43 are 110° C. to 130° C., meeting requirements for both high-temperature storage and timely pressure relief.

TABLE 2
Remaining parameters and test results of batteries
in Comparative Examples 3 and 4 and Examples 6-10

| | Comparative | Comparative | Example | Example | Example | Example | Example |
|---|---|---|---|---|---|---|---|
| Group | Example 3 | Example 4 | 6 | 7 | 8 | 9 | 10 |
| T1 (° C.) | 110 | 123 | 123 | 123 | 123 | 123 | 123 |
| T2 (° C.) | 115 | 180 | 140 | 145 | 150 | 165 | 170 |
| T3 (° C.) | 110 | 123 | 123 | 123 | 123 | 123 | 123 |
| Sealing | 3.2 | 3.2 | 3.2 | 3.2 | 3.2 | 3.2 | 3.2 |
| strength at | | | | | | | |
| room | | | | | | | |
| temperature | | | | | | | |
| (N/mm) | | | | | | | |
| Sealing | 1.2 | 1.2 | 1.2 | 1.2 | 1.2 | 1.2 | 1.2 |
| strength at | | | | | | | |
| 100° C. | | | | | | | |
| (N/mm) | | | | | | | |
| Sealing | 0.9 | 0.9 | 0.9 | 0.9 | 0.9 | 0.9 | 0.9 |
| strength at | | | | | | | |
| 120° C. | | | | | | | |
| (N/mm) | | | | | | | |
| Sealing | 0.3 | 0.3 | 0.3 | 0.3 | 0.3 | 0.3 | 0.3 |
| strength at | | | | | | | |
| 130° C. | | | | | | | |
| (N/mm) | | | | | | | |
| Sum of | 75 | 75 | 75 | 75 | 75 | 75 | 75 |
| thicknesses | | | | | | | |
| (μm) | | | | | | | |
| Thickness | 1:1.6:1 | 1:1.6:1 | 1:1.6:1 | 1:1.6:1 | 1:1.6:1 | 1:1.6:1 | 1:1.6:1 |
| ratio | | | | | | | |
| Pass rate of | 100% | 100% | 100% | 100% | 100% | 100% | 100% |
| hot box test | | | | | | | |
| Pass rate of | 50% | 100% | 100% | 100% | 100% | 100% | 100% |
| 100° C. | | | | | | | |
| storage test | | | | | | | |

From Table 2, it can be seen that in Comparative Example 3, the melting point of the second adhesive layer 42 is less than 140° C., which is unfavorable for high-temperature storage of the battery 100. In Comparative Example 4, the melting point of the second adhesive layer 42 is greater than 170° C., which, although meeting pressure relief test requirements, makes material selection for the tab adhesive 40 more stringent and preparation more difficult. In Examples 6-10, the melting point of the second adhesive layer 42 is 140° C. to 170° C., meeting requirements for both high-temperature storage and timely pressure relief.

TABLE 3
Remaining parameters and test results of batteries
in Comparative Examples 5 and 6 and Examples 11-14

| | Comparative | Comparative | Example | Example | Example | Example |
|---|---|---|---|---|---|---|
| Group | Example 5 | Example 6 | 11 | 12 | 13 | 14 |
| T1 (° C.) | 123 | 123 | 123 | 123 | 123 | 123 |
| T2 (° C.) | 165 | 165 | 165 | 165 | 165 | 165 |
| T3 (° C.) | 123 | 123 | 123 | 123 | 123 | 123 |
| Sealing | 2.0 | 5 | 2.5 | 3 | 3.5 | 4 |
| strength at | | | | | | |
| room | | | | | | |
| temperature | | | | | | |
| (N/mm) | | | | | | |
| Sealing | 1 | 1.8 | 1.2 | 1.3 | 1.4 | 1.5 |
| strength at | | | | | | |
| 100° C. | | | | | | |
| (N/mm) | | | | | | |
| Sealing | 0.4 | 1.4 | 0.6 | 0.8 | 1 | 1.2 |
| strength at | | | | | | |
| 120° C. | | | | | | |
| (N/mm) | | | | | | |
| Sealing | 0.1 | 0.5 | 0.2 | 0.3 | 0.4 | 0.5 |
| strength at | | | | | | |
| 130° C. | | | | | | |
| (N/mm) | | | | | | |
| Sum of | 75 | 75 | 75 | 75 | 75 | 75 |
| thicknesses | | | | | | |
| (μm) | | | | | | |
| Thickness | 1:1.6:1 | 1:1.6:1 | 1:1.6:1 | 1:1.6:1 | 1:1.6:1 | 1:1.6:1 |
| ratio | | | | | | |
| Pass rate of | 100% | 80% | 100% | 100% | 100% | 100% |
| hot box test | | | | | | |
| Pass rate of | 80% | 100% | 100% | 100% | 100% | 100% |
| 100° C. | | | | | | |
| storage test | | | | | | |

From Table 3, it can be seen that in Comparative Example 5, the sealing strength of the tab adhesive 40 is low, which, although meeting pressure relief test requirements, results in low sealing strength at room temperature, unfavorable for use of the battery 100. In Comparative Example 6, the sealing strength of the tab adhesive 40 is high, unfavorable for timely pressure relief of the battery 100. In Examples 11-14, the sealing strength of the tab adhesive 40 meets the ranges specified above, meeting requirements for both high-temperature storage and timely pressure relief.

TABLE 4
Remaining parameters and test results of batteries
in Comparative Examples 7 and 8 and Examples 15-18

| | Comparative | Comparative | Example | Example | Example | Example |
|---|---|---|---|---|---|---|
| Group | Example 7 | Example 8 | 15 | 16 | 17 | 18 |
| T1 (° C.) | 123 | 123 | 123 | 123 | 123 | 123 |
| T2 (° C.) | 165 | 165 | 165 | 165 | 165 | 165 |
| T3 (° C.) | 123 | 123 | 123 | 123 | 123 | 123 |
| Sealing | 3.2 | 3.2 | 3.2 | 3.2 | 3.2 | 3.2 |
| strength at | | | | | | |
| room | | | | | | |
| temperature | | | | | | |
| (N/mm) | | | | | | |
| Sealing | 1.2 | 1.2 | 1.2 | 1.2 | 1.2 | 1.2 |
| strength at | | | | | | |
| 100° C. | | | | | | |
| (N/mm) | | | | | | |
| Sealing | 0.9 | 0.9 | 0.9 | 0.9 | 0.9 | 0.9 |
| strength at | | | | | | |
| 120° C. | | | | | | |
| (N/mm) | | | | | | |
| Sealing | 0.3 | 0.3 | 0.3 | 0.3 | 0.3 | 0.3 |
| strength at | | | | | | |
| 130° C. | | | | | | |
| (N/mm) | | | | | | |
| Sum of | 75 | 75 | 75 | 75 | 75 | 75 |
| thicknesses | | | | | | |
| (μm) | | | | | | |
| Thickness | 1:1.0:1 | 1:2.5:1 | 1:1.2:1 | 1:1.5:1 | 1:1.8:1 | 1:2.0:1 |
| ratio | | | | | | |
| Pass rate of | 100% | 85% | 100% | 100% | 100% | 95% |
| hot box test | | | | | | |
| Pass rate of | 85% | 100% | 95% | 100% | 100% | 100% |
| 100° C. | | | | | | |
| storage test | | | | | | |

From Table 4, it can be seen that in Comparative Example 7, when a thickness ratio of the first adhesive layer 41 to the second adhesive layer 42 is large, pass rates for the hot box test and the high temperature storage test are low. In Comparative Example 8, when the thickness ratio of the first adhesive layer 41 to the second adhesive layer 42 is small, the thicknesses of the first adhesive layer 41 and the third adhesive layer 43 are thin, affecting the pass rate of the hot box test.

In summary, in the above battery 100 and electrical device 200, by specifying the melting points and thicknesses of the first adhesive layer 41, the second adhesive layer 42, and the third adhesive layer 43 in the tab adhesive 40, the tab adhesive 40 maintains a stable structure during pressure relief. Specifically, the melting point of the second adhesive layer 42 is higher than the melting points of the first adhesive layer 41 and the third adhesive layer 43, such that when the temperature of the tab adhesive 40 reaches the melting points of the first adhesive layer 41 and the third adhesive layer 43, the second adhesive layer 42 remains unmelted, helping the second adhesive layer 42 to form a supporting structure between the tab 30 and the first sealing edge 21 during heat sealing or pressure relief. Additionally, the thickness of the second adhesive layer 42 is greater than the thickness of the first adhesive layer 41, enabling the second adhesive layer 42 to have higher structural strength compared to the first adhesive layer 41, thereby enhancing stability of the support provided by the second adhesive layer 42 between the tab 30 and the first sealing edge 21. This reduces a risk of exposure of the tab 30 due to excessive deformation of the tab adhesive 40 causing a short circuit with metal materials in the packaging bag 20, thus improving safety performance of the battery 100.

Additionally, those skilled in the art may make other changes within the spirit of the present application. Naturally, these changes made in accordance with the spirit of the present application should be included within the scope disclosed by the present application.

What is claimed is:

1. A battery, comprising an electrode assembly, a packaging bag, and a tab; wherein the electrode assembly is accommodated in the packaging bag; wherein,
the packaging bag comprises a first sealing edge, and the tab is connected to the electrode assembly and extends out of the packaging bag from the first sealing edge;
the battery further comprises a tab adhesive disposed between the first sealing edge and the tab; wherein the tab adhesive comprises a first adhesive layer, a second adhesive layer, and a third adhesive layer sequentially connected in a direction from the tab to the first sealing edge; a melting point T1 of the first adhesive layer, a melting point T2 of the second adhesive layer, and a melting point T3 of the third adhesive layer satisfy: T1<T2, and T3<T2, wherein 110° C.≤T1≤130° C., 140° C.≤T2≤170° C., and 110° C.≤T3≤130° C.; and
in an stacking direction of the first adhesive layer, the second adhesive layer, and the third adhesive layer, a sum of thicknesses of the first adhesive layer, the second adhesive layer, and the third adhesive layer is 70 μm to 100 μm, and a thickness ratio of the first adhesive layer to the second adhesive layer satisfies 1:1.2-2.

2. The battery according to claim 1, wherein T1 is substantially equal to T3.

3. The battery according to claim 1, wherein the sum of the thicknesses of the first adhesive layer, the second adhesive layer, and the third adhesive layer is 72 μm to 80 μm.

4. The battery according to claim 3, wherein a thickness ratio of the first adhesive layer, the second adhesive layer, and the third adhesive layer satisfies 1:1.2-2:1.

5. The battery according to claim 4, wherein the thickness ratio of the first adhesive layer, the second adhesive layer, and the third adhesive layer satisfies 1:1.5-1.8:1.

6. The battery according to claim 1, wherein 120° C.≤T1≤125° C., 145° C.≤T2≤165° C., and 120° C.≤T3≤125° C.

7. The battery according to claim 1, wherein a sealing strength of the tab adhesive at a temperature of 100° C. is 0.8 N/mm to 1.5 N/mm.

8. The battery according to claim 7, wherein the sealing strength of the tab adhesive at a temperature of 120° C. is 0.6 N/mm to 1.2 N/mm.

9. The battery according to claim 8, wherein the sealing strength of the tab adhesive at a temperature of 130° C. is 0.2 N/mm to 0.5 N/mm.

10. The battery according to claim 9, wherein the sealing strength of the tab adhesive at room temperature is 2.3 N/mm to 4.25 N/mm.

11. The battery according to claim 1, wherein, viewed along a thickness direction of the tab, the tab adhesive comprises a top portion, a bottom portion, a first side portion, and a second side portion; wherein the top portion and the bottom portion are oppositely disposed in an extension direction of the tab, the top portion is located outside the first sealing edge, the bottom portion is located inside the packaging bag, and the first side portion and the second side portion are connected between the top portion and the bottom portion and are disposed on two sides of the tab along a width direction of the tab.

12. The battery according to claim 11, wherein, along the extension direction of the tab, a width of the first sealing edge is 1.2 mm to 2.0 mm; and along the width direction of the tab, a spacing between the first side portion and the second side portion is 8 mm to 9 mm.

13. The battery according to claim 1, wherein a length by which the top portion protrudes beyond the first sealing edge is 0.2 mm to 2 mm.

14. The battery according to claim 13, wherein a length by which the bottom portion protrudes beyond the first sealing edge is greater than 1.2 mm.

15. The battery according to claim 13, wherein the length by which the top portion protrudes beyond the first sealing edge is 0.8 mm to 2 mm.

16. The battery according to claim 12, wherein, along the extension direction of the tab, a spacing between the top portion and the bottom portion is 2.5 mm to 5 mm.

17. The battery according to claim 12, wherein, along the width direction of the tab, a spacing between a side edge of the tab facing the first side portion and the first side portion is 0.5 mm to 2.5 mm, and a spacing between a side edge of the tab facing the second side portion and the second side portion is 0.5 mm to 2.5 mm.

18. The battery according to claim 17, wherein, along the width direction of the tab, a spacing between a side edge of the tab facing the first side portion and the first side portion is 2 mm to 2.5 mm, and a spacing between a side edge of the tab facing the second side portion and the second side portion is 2 mm to 2.5 mm.

19. The battery according to claim 1, wherein the tab comprises a first surface and a second surface oppositely disposed in a thickness direction of the tab, and the tab adhesive comprises a first portion and a second portion, wherein the first portion is connected between the first surface and the first sealing edge, the second portion is connected between the second surface and the first sealing edge; and along a width direction of the tab, two ends of the first portion protruding beyond the first surface are connected to two ends of the second portion protruding beyond the second surface.

20. An electrical device, wherein the electrical device comprises the battery according to claim 1.
